(19) United States
(12) Patent Application Publication
(10) Pub. No.: US 2012/0104211 A1
(43) Pub. Date: May 3, 2012

(54) SCREW-OPERATED CLAMPING MECHANISM AND METHOD OF USING THE SAME

(75) Inventor: Hiroshi Saijo, Kawasaki-shi (JP)

(73) Assignee: RECTRON CO., LTD., Kawasaki-shi (JP)

(21) Appl. No.: 13/278,258

(22) Filed: Oct. 21, 2011

(30) Foreign Application Priority Data
Oct. 27, 2010 (JP) 2010-240274
Jun. 30, 2011 (JP) 2011-146074

(51) Int. Cl. F16B 2/12

(52) U.S. Cl. 248/316.4

(57) ABSTRACT

A screw-operated clamping mechanism comprises a clamp body, a shaft attached to a side of the clamp body, a movable pawl which is slidably attached to the shaft, a knob which is allowed to slide and turn relative to the shaft, an I-shaped nut which is rotatably screwed onto a threaded portion formed in the shaft, and a stopper attached to an end of the shaft. The knob is provided, at a side facing the I-shaped nut, with a first contact face with which the I-shaped nut comes in contact, a concave nut receiving groove formed in the first contact face, a second contact face which is formed at the bottom of the nut receiving groove and with which the I-shaped nut comes in contact, and nut locking parts which project from the first contact face and set the knob and the I-shaped nut to be turned integrally.

### BACKGROUND OF THE INVENTION

The present invention relates to a screw-operated clamping mechanism enabling quick attachment and removal of a camera or the like relative to a platform such as a tripod and a method of using the clamping mechanism.

Conventionally, for attaching and removing a camera relative to a camera platform such as a tripod, a releasable clamping mechanism is attached to an upper portion of the camera platform. ARCA-type clamping mechanisms of ARCA-SWISS compose the major market in the world. The ARCA-type clamping mechanisms may be categorized into two groups, i.e. screw-operated clamping mechanism of which clamping is based on vice's principle and lever-operated clamping mechanism enabling quick opening and closing.

FIGS. 14A, 14B, 15A, and 15B show an ARCA-type lever-operated clamping mechanism. FIGS. 14A, 14B are a plan view and a side view showing an open state of the lever-operated clamping mechanism and FIGS. 15A, 15B are a plan view and a side view showing a closed state of the lever-operated clamping mechanism, respectively. FIG. 14B and FIG. 15B includes a plate 7 to be attached to/removed from the lever-operated clamping mechanism.

As shown in FIGS. 14A, 14B, 15A, 15B, the lever-operated clamping mechanism comprises a clamp body 8, a movable pawl 6 which is slidably disposed on one side of the clamp body 8, and an operating lever 9. By pivotal movement of the operating lever 9, the movable pawl 6 is brought to close to and away from the clamp body 8. The clamp body 8 is attached to an upper portion of a camera platform (not shown) and the plate 7 is attached to a bottom of a camera. As shown in FIGS. 14A, 14B, the movable pawl 6 is separated from the clamp body 8 by moving the operating lever 9 to pivot in the opening direction. In this state, the plate 7 attached to the camera is placed on the clamp body 8. After that, as shown in FIGS. 15A, 15B, the movable pawl 6 is brought to close to the clamp body 8 by moving the operating lever 9 to pivot in the closing direction, thereby fixing the plate 7 on the clamp body 8.

FIGS. 16A, 16B show an ARCA-type screw-operated clamping mechanism. FIG. 16A is a side view showing an open state of the screw-operated clamping mechanism and FIG. 16B is a side view showing a closed state of the screw-operated clamping mechanism. FIGS. 16A, 16B include a plate 7 to be attached to/removed from the screw-operated clamping mechanism.

As shown in FIGS. 16A, 16B, the screw-operated clamping mechanism comprises a clamp body 8, a movable pawl 6 which is slidably fitted onto a shaft 4 projecting from one side of the clamp body 8, and a knob 1 screwed onto a thread formed in a rear portion of the shaft 4. By turning the knob 1, the movable pawl 6 is brought to close to and away from the clamp body 8. As shown in FIG. 16A, the movable pawl 6 is separated from the clamp body 8 by turning the knob 1 in the opening direction. In this state, the plate 7 is placed on the clamp body 8. After that, as shown in FIG. 16B, the movable pawl 6 is brought to close to the clamp body 8 by turning the knob 1 in the closing direction, thereby fixing the plate 7 on the clamp body 8. That is, the opening and closing of the screw-operated clamping mechanism is conducted by turning the knob 1 so that the knob 1 moves forward and backward by means of a simple combination of the external thread of the shaft 4 fixed to the clamp body 8 and the internal thread formed in the inner periphery of the knob 1.
[Related patent document] JP-UM-A-49-36936

In case of the lever-operated clamping mechanism shown in FIGS. 14A, 14B, 15A, 15B, quick attachment and removal is achieved just by moving the operating lever 9 to pivot by about 90 degree. Because of its structure, however, the lever-operated clamping mechanism does not provide such strong holding force as obtained by the screw-operated clamping mechanism. Therefore, from the aspect of reliability, the lever-operated clamping mechanism is unsuitable for heavy shooting equipment. Additionally, since plates 7 have slightly different sizes depending on the manufacturer, if a lever-operated clamping mechanism for securely holding a slightly large size plate 7 is used for holding a slightly small size plate 7, the mechanism may provide poor holding force or cannot hold the plate 7.

On the other hand, the screw-operated clamping mechanism shown in FIGS. 16A, 16B can be used for holding heavy shooting equipment with high reliability because strong holding force is obtained by turning the knob 1. The screw-operated clamping mechanism responds to various plates 7 which are slightly different in size so that there is no problem because it can fit any just by changing the number of turning the knob 1. For attaching or removing the plate 7, however, it is required to turn the knob 1 many times. Especially when you need to repeat movement and shooting (that is, you need to attach and remove the camera many times), it is very troublesome. This means that the screw-operated clamping mechanism has poor mobility.

### SUMMARY OF THE INVENTION

The present invention was made in the light of the above described problems and the object of the present invention is to provide a screw-operated clamping mechanism having improved operability and enabling such quick attachment and removal as provided by the lever-operated clamping mechanism with no loss of reliable and secure screw-operated fixing method and to provide a method using the same.

To achieve the aforementioned object, an invention claimed in claim 1 provides a screw-operated clamping mechanism comprising at least: a clamp body having a plate mounting face on which a plate is mounted and a fixed pawl formed on the upper surface at an end of one of sides; a shaft attached to a side, opposite to the side where said fixed pawl is formed, of said clamp body; a movable pawl which is slidably attached to said shaft; a knob which is disposed on the back side of said movable pawl and is allowed to slide and turn relative to said shaft; a nut which is allowed to turn and screw to a threaded portion formed in said shaft penetrating said knob; and a stopper attached to an end of said shaft, wherein said knob is provided, at a side facing said nut, with a first contact face with which said nut comes in contact, a concave nut receiving groove formed in said first contact face, a second contact face which is formed at the bottom of said nut receiving groove and with which said nut comes in contact, and a nut locking part which projects from said first contact face and comes in contact with a side of said nut so that said knob and said nut are turned integrally, and wherein, by bringing the side of said nut in contact with said nut locking part or said nut receiving groove of said knob and turning said nut together with said knob, said nut is pressed against said first contact face or said second contact face of said knob so as to move said movable pawl toward said clamp body via said knob and press said movable pawl against said plate put on said plate mounting face so that said plate is clamped and fixed between said movable pawl and said fixed pawl.

The screw-operated clamping mechanism of this invention is basically a screw-operated system, but is not a system like a conventional screw-operated clamping mechanism in which a movable pawl is clamped directly by internal thread of a knob itself. The screw-operated clamping mechanism of this invention is a system in which a nut is incorporated into a knob and a movable pawl is clamped indirectly by the knob via the nut.

An invention claimed in claim 2 provides a method of using a screw-operated clamping mechanism as claimed in claim 1, comprising steps of: previously moving said knob backward and inserting said nut into said nut receiving groove to move said movable pawl backward and, in this state, putting said plate on said clamp body; moving said knob forward relative to said nut to position said nut above said nut receiving groove; and turning said knob in the clamping direction until said nut faces said first contact face and further turning said knob in the clamping direction to turn and move said nut forward until said nut is pressed against said first contact face so that said movable pawl is pressed against said plate via said knob so as to clamp and fix said plate between said movable pawl and said fixed pawl.

An invention claimed in claim 3 provides a method of using a screw-operated clamping mechanism as claimed in claim 1, comprising steps of: previously moving said knob backward and inserting said nut into said nut receiving groove to move said movable pawl backward and, in this state, putting said plate on said clamp body; and turning said knob in the clamping direction while said nut is inserted in said nut receiving groove so as to turn said nut in said nut receiving groove and move said nut forward until said nut is pressed against said second contact face so that said movable pawl is pressed against said plate via said knob so as to clamp and fix said plate between said movable pawl and said fixed pawl.

According to the invention claimed in claim 1, the knob for clamping has a stepped inner structure, i.e. the first contact face and the second contact face which are stepped between them. Therefore, there is a choice between two fixing ways, i.e. a case where the plate is fixed by pressing the nut against the first contact face and a case where the plate is fixed by pressing the nut against the second contact face. In case where the plate is fixed by pressing the nut against the first contact face, the quick and secure attachment and removal of the plate is achieved only by the minimal operation of turning the knob. In case where the plate is fixed by pressing the nut against the second contact face, the operational feeling similar to that of the conventional screw-operated clamping mechanism is obtained. When quick attachment and removal is required, the attachment and removal of the plate can be obtained only by the one or two turns of the knob (quick clamping operational mode). On the other hand, when quick operation is not required, the same function as the conventional screw-operated clamping mechanism is obtained (normal clamping operational mode). Just one mechanism allows for flexible handling corresponding to shooting conditions. Further, according to the structure of the present invention, there is no difference in fixing force depending on the size of plate. Because it is screw-operated, unlike the conventional lever-operated clamping mechanism, the clamping mechanism of this invention can be used for various plates even though these have slightly different sizes depending on the manufacturer.

According to the invention claimed in claim 2, the screw-operated clamping mechanism of the present invention can be used in the quick clamping operational mode by turning the knob in the clamping direction while the nut is positioned above the nut receiving groove. Therefore, the quick and secure attachment and removal of the plate is enabled only by the minimum turning operation of the knob. As a result of this, the screw-operated clamping mechanism has significantly improved mobility in the shooting location while keeping high reliability as the screw-operated clamping mechanism.

According to the invention claimed in claim 3, the screw-operated clamping mechanism of the present invention can be used in the normal clamping operational mode similar to the conventional screw-operated clamping mechanism. For the purpose of preventing the equipment from falling down due to incorrect operation, there is a case that the same function as the conventional screw-operated clamping mechanism is better for ease of use. Examples include a case of attaching a camera with a heavy telescopic lens to a tripod. In such a case, the attachment and removal of the camera may be not frequently required. This invention is a using method taking such situation into consideration.

### BRIEF DESCRIPTION OF THE DRAWINGS

FIGS. 1A, 1B are structural illustrations for an embodiment of a screw-operated clamping mechanism, FIG. 1A is a side view thereof and FIG. 1B is a front view (view of operating side) thereof;

FIG. 2 is an exploded side view of a major part of the screw-operated clamping mechanism;

FIG. 3 is a perspective view showing a knob 1 and an I-shaped nut 2;

FIGS. 4A, 4B, 5A, 5B, 6A, 6B, 7A, 7B, 8A, 8B are operational explanatory illustrations of the screw-operated clamping mechanism in a quick clamping operational mode;

FIGS. 9A, 9B, 10A, 10B, 11A, 11B, 12A, 12B, 13A, 13B are operational explanatory illustrations of the screw-operated clamping mechanism in a normal clamping operational mode;

FIGS. 14A, 14B, 15A, 15B are operational explanatory illustrations of a conventional lever-operated clamping mechanism;

FIGS. 16A, 16B are operational explanatory illustrations of a conventional screw-operated clamping mechanism;

FIGS. 17A, 17B, 1BA, 18B, 19A, 19B, 20A, 20B are operational explanatory illustrations of another screw-operated clamping mechanism in a quick clamping operational mode; and

FIGS. 21A, 21B, 22A, 22B are operational explanatory illustrations of the screw-operated clamping mechanism in a normal clamping operational mode.

### DESCRIPTION OF THE PREFERRED EMBODIMENT

Hereinafter, embodiments of the present invention will be described in detail with reference to drawings.

### First Embodiment

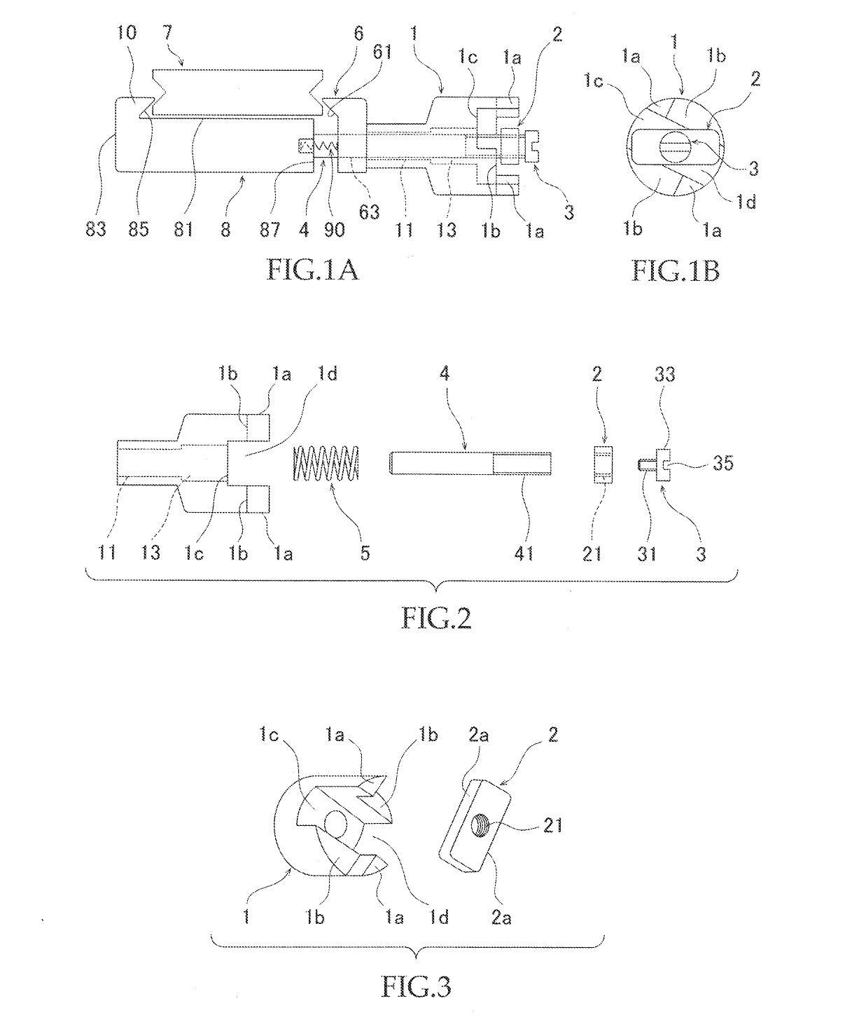

FIGS. 1A, 1B are structural illustrations of a screw-operated clamping mechanism according to a first embodiment of the present invention. FIG. 1A is a side view thereof (a plate 7 is illustrated but a spring 5 is omitted) and FIG. 1B is a front view thereof (a clamp body 8 and a movable pawl 6 are omitted). FIG. 2 is an exploded side view of a major part of the screw-operated clamping mechanism and FIG. 3 is a perspective view showing an I-shaped nut 2 and an internal structure of a knob 1 on a side facing the I-shaped nut 2. As shown in these drawings, the screw-operated clamping mechanism comprises a clamp body 8, a shaft 4, a movable pawl 6, a knob 1, a nut (hereinafter, referred to as “I-shaped nut”) 2, a stopper 3, and biasing means (hereinafter, referred to as “spring”) 5.

The clamp body 8 is of a plate-like rectangular shape (similar to the aforementioned clamp body 8 shown in FIG. 14A) having a plate mounting surface 81 on which the plate 7 is mounted and a fixed pawl 10 formed on a top of a portion on one side 83. The fixed pawl 10 extends the entire length of the side 83 and is provided with a sharply-angled projection above the surface of the plate mounting surface 81 so that the lower surface of the sharply-angled projection functions as a plate stopping portion 85, similarly to the case shown in FIGS. 14A, 14B.

The shaft 4 is cylindrical, is inserted into a bore formed in substantially the center of the side 87 opposite to the side 83 on which the fixed pawl 10 is formed, and is fixed to project perpendicularly from the surface of the side 87. At an end of the shaft 4, an internal thread (not shown) for screwing the stopper 3 is formed. Additionally, a threaded portion 41 (see FIG. 2) for screwing the I-shaped nut 2 is formed in the outer periphery of a portion near the end.

The movable pawl 6 is substantially rectangular having substantially the same width as the clamp body 8 and is provided with a sharply angled projection formed on an upper portion of its surface facing the clamp body 8 so that the lower surface of the sharply-angled projection functions as a plate engaging portion 61, similarly to the movable pawl 6 shown in FIGS. 14A, 14B. At substantially the center of the movable pawl 6, a circular hole 63 through which the shaft 4 is slidably inserted is formed.

The knob 1 is cylindrical of which a portion apart from the movable pawl 6 has a diameter larger than that of a portion near the movable pawl 6. At a central axial portion of the knob 1, a bore 11 through which the shaft 4 is slidably and rotatably inserted is formed. A portion of the bore 11 apart from the movable pawl 6 has an inner diameter larger than the other portion so as to function as a spring receiving portion 13. On a side facing the I-shaped nut 2, as shown in FIG. 3, the knob 1 has a first contact face 1b to be contact with the I-shaped nut 2, a nut receiving groove 1d as a rectangular concave formed in the first contact face 1b, a second contact face 1c formed in a bottom of the nut receiving groove 1d, and a pair of nut locking parts 1a projecting from (portions of) the pair of sections of first contact face 1b separated by the nut receiving groove 1d. The nut receiving groove 1d is formed to have such a dimension as to nearly tightly fit the I-shaped nut 2. The pair of nut locking parts 1a are formed such that, when the I-shaped nut 2 is inserted between the nut locking parts 1a and is brought in contact with the first contact face 1b, the nut locking parts 1a come in contact with portions near opposite ends of opposite side faces 2a of the I-shaped nut 2 so as to allow the I-shaped nut 2 to rotate in one direction. Above the nut receiving groove 1d, the I-shaped nut 2 is allowed to rotate between the pair of nut locking parts 1a by a predetermined angle (90° in this embodiment) so as to travel between two positions where the I-shaped nut 2 is in contact with the nut locking parts 1a. At one of the positions, the I-shaped nut 2 is in contact with the first contact face 1b of the knob 1. At the other position, the I-shaped nut 2 is allowed to be inserted into the nut receiving groove 1d of the knob 1.

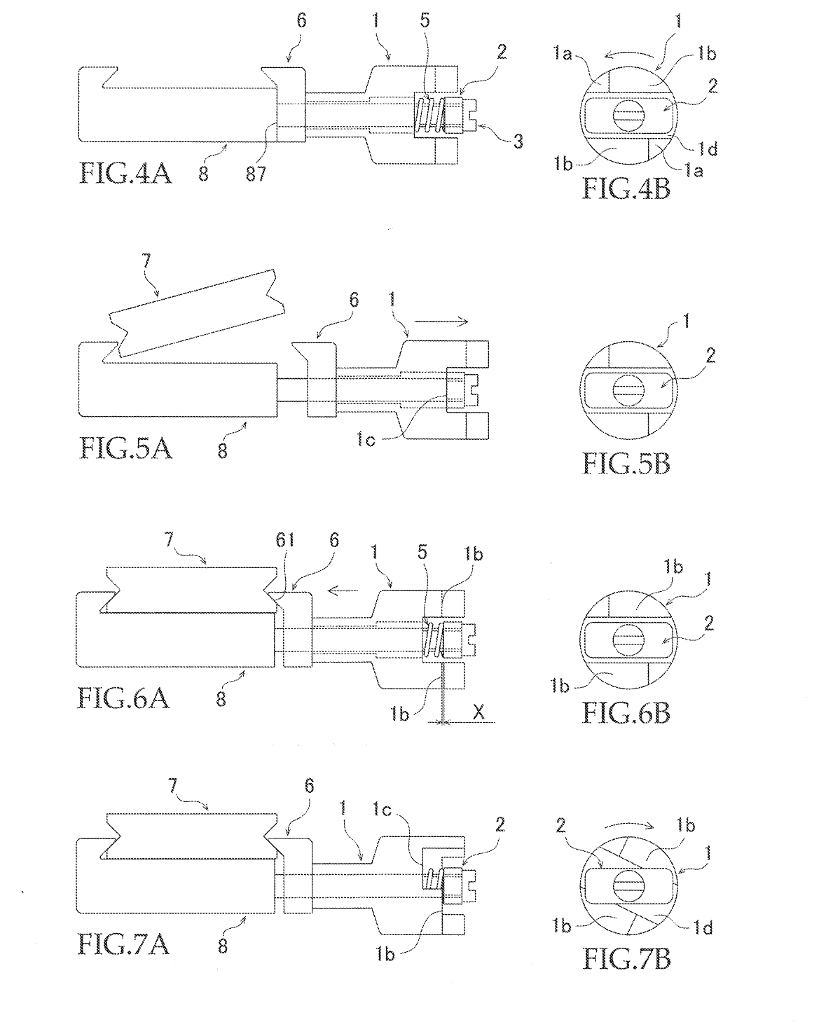

The I-shaped nut 2 is formed in a substantially rectangular plate-like shape and has a through hole formed in the center thereof and an internal thread 21 formed in the through hole for screwing the threaded portion 41 of the aforementioned shaft 4. The stopper 3 has an external thread portion 31, a head 33 at one end of the external thread portion 31, and a screwdriver receiving groove 35 formed in the head 33. The spring 5 is a coil spring and has such an internal diameter as to allow the insertion of the shaft 4 and such an external diameter that the spring 5 is allowed to be inserted into the spring receiving portion 13 of the knob 1 but is not allowed to be inserted into the bore 11. For assembling the screw-operated clamping mechanism, first one end of the shaft 4 is inserted into and fixed to the bore (not shown) formed in the side 87 of the clamp body 8, the shaft 4 is further inserted into the hole 63 of the movable pawl 6 and the bore 11 of the knob 1, then the spring 5 is put onto the shaft 4, the internal thread 21 of the I-shaped nut 2 is rotatably screwed onto the threaded portion 41 of the shaft 4 after inserted into the knob 1, and the external thread portion 31 of the stopper 3 is screwed into the internal thread at the end of the shaft 4 so that the stopper 3 is fixed to the shaft 4. It should be noted that there are biasing means 90 such as coil springs between the movable pawl 6 and the side 87 of the clamp body 8. By the biasing means 90, the movable pawl 6 is always biased in a direction apart from the clamp body 8. The pair of biasing means 90 are disposed at two positions on both horizontal sides of the shaft 4 (The two positions are a near side and a far side relative to the paper showing FIG. 1A. Only the biasing means 90 at the near side is illustrated in FIG. 1A). The biasing force of the movable pawl 6 by the aforementioned spring 5 is set to be larger than the biasing force of the movable pawl 6 by the pair of biasing means 90. Therefore, when no plate 7 is attached and no external force is applied, the movable pawl 6 is in contact with the side 87 of the clamp body 8 as shown in FIG. 4A. For your information, the biasing means 90 are not illustrated in FIGS. 4A, 5A, 6A, 7A, 8A, 9A, 10A, 11A, 12A, 13A, 17A, 18A, 19A, 20A, 21A, and 22A. It should be understood that the abovementioned assembling procedure is an example so that the screw-operated clamping mechanism may be assembled in another way. Actually, a cover is mounted to cover the nut locking parts 1a, the stopper 3, the I-shaped nut 2, and the like from the outer periphery of the large-diameter portion of the knob 1, but not shown.

In the screw-operated clamping mechanism having the aforementioned structure, as shown in FIG. 4A, the I-shaped nut 2 and the knob 1 are biased apart from each other by the spring 5 so that the end face of the small-diameter portion of the knob 1 reaches and pushes the movable pawl 6 and the movable pawl 6 thus comes in contact with the side 87 of the clamping body 8.

### [Quick Clamping Operational Mode]

FIGS. 4A, 4B, 5A, 5B, 6A, 6B, 7A, 7B, 8A, 8B are operational explanatory illustrations of the screw-operated clamping mechanism in a quick clamping operational mode, wherein FIGS. 4A, 5A, 6A, 7A, 8A are side views and FIGS. 4B, 5B, 6B, 7B, 8B are front views (operational sides) (the clamp body 8 and the movable pawl 6 are omitted). Before the insertion of the plate 7, the knob 1 is turned in the counterclockwise direction or the unclamping direction such that the I-shaped nut 2 moves back to reach the stopper 3 as the backmost as shown in FIGS. 4A, 4B. The I-shaped nut 2 when stopped is positioned above the nut receiving groove 1d (the I-shaped nut 2 is not inserted into the nut receiving groove 1d) and between the nut locking parts 1a so that the I-shaped nut 2 is parallel to the second contact face 1c (the I-shaped nut 2 is allowed to be fitly inserted into the nut receiving groove 1d).

Then, as shown in FIGS. 5A, 5B, the knob 1 is pulled backward (in a direction apart from the clamp body 8). With this, the knob 1 and the movable pawl 6 are moved backward widely until the I-shaped nut 2 is inserted into the nut receiving groove 1d (for example, until the I-shaped nut 2 comes in contact with the second contact face 1c of the knob 1) so that the screw-operated clamping mechanism becomes in a state allowing the plate 7 to be mounted on the plate body 8. Then the plate 7 is mounted.

After the plate 7 is mounted, as shown in FIGS. 6A, 6B, the pulling of the knob 1 is cancelled so that the knob 1 and the movable pawl 6 are moved forward by the biasing force of the spring 5 and stop when the plate engaging portion 61 of the movable pawl 6 is caught by a side of the plate 7. Since the I-shaped nut 2 is positioned at the backmost, the first contact face 1b of the knob 1 is shifted forward from the I-shaped nut 2 so that a space X is created between the first contact face 1b and the I-shaped nut 2.

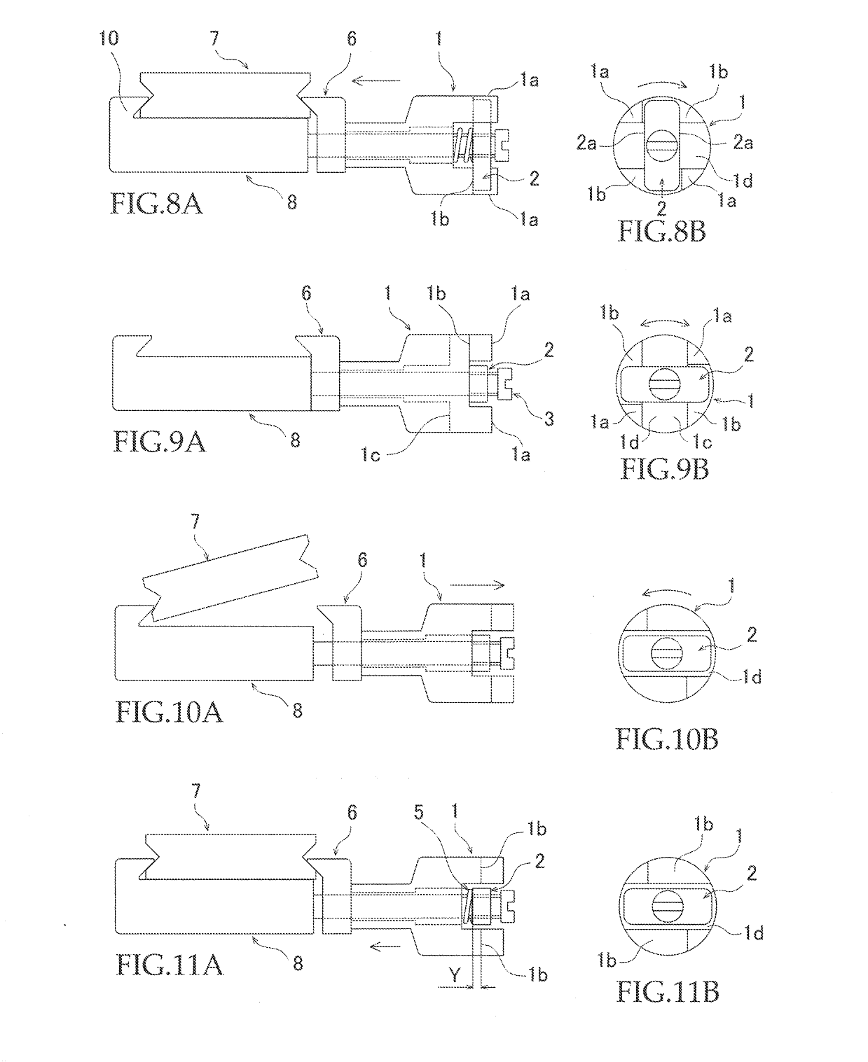

Then, as shown in FIGS. 7A, 7B, the knob 1 is turned in the clockwise direction or the clamping direction so that the I-shaped nut 2 is kept stopped while the knob 1 is turned. As the knob 1 is further turned, as shown in FIGS. 8A, 8B, the nut locking parts 1a of the knob 1 come in contact with the side faces 2a of the I-shaped nut 2. After that, the knob 1 and the I-shaped nut 2 are simultaneously turned in the same direction or the clockwise direction. By the turning of the I-shaped nut 2, the I-shaped nut 2 moves along the shaft 4 toward the clamp body 8 and thus presses the first contact face 1b of the knob 1 to move the knob 1 and the movable pawl 6 toward the clamp body 8. Therefore, as shown in FIGS. 8A, 8B, the plate 7 is clamped between the movable pawl 6 and the fixed pawl 10, thereby securely fixing the plate 7 on the clamp body 8.

By turning the knob 1 by 90° in the counterclockwise direction or the unclamping direction, the I-shaped nut 2 is kept at the position shown in FIGS. 8A, 8B while only the knob 1 is turned by 90° in the counterclockwise direction so that the I-shaped nut 2 is slightly spaced apart from the first contact face 1b. That is, the I-shaped nut 2 becomes parallel to the nut receiving groove 1d. By pulling the knob 1 backward from this state, the I-shaped nut 2 is inserted into the nut insertion groove 1d, thereby easily allowing the plate 7 to be removed. Only by turning the knob 1 by 90° in the clockwise direction or the clamping direction after the knob 1 is pulled again and the plate 7 is put on again, the state shown in FIGS. 8A, 8B is returned, thereby securely fixing the plate 7.

Therefore, the quick and secure attachment and removal of the plate 7 is achieved by the operation of turning the knob 1 by 90°. As a result of this, the screw-operated clamping mechanism of this embodiment has significantly improved mobility in the shooting location while keeping high reliability as the screw-operated clamping mechanism.

That is, the screw-operated clamping mechanism of this embodiment can be used in the quick clamping operational mode by positioning the I-shaped nut 2 above the nut receiving groove 1d.

### [Normal Clamping Operational Mode]

FIGS. 9A, 9B, 10A, 10B, 11A, 11B, 12A, 12B, 13A, 13B are operational explanatory illustrations of the screw-operated clamping mechanism in a normal clamping operational mode, wherein FIGS. 9A, 10A, 11A, 12A, 13A are side views and FIGS. 9B, 10B, 11B, 12B, 13B are front views (operational sides) (the clamp body 8 and the movable pawl 6 are omitted). Before the insertion of the plate 7, the knob 1 is turned in the counterclockwise direction or the unclamping direction until the I-shaped nut 2 reaches the stopper 3 as the backmost (as shown in FIGS. 4A, 4B). Then, the knob 1 is turned in the clockwise direction or the clamping direction until stopped (as shown in FIGS. 9A, 9B). Accordingly, the I-shaped nut 2 is pressed onto the first contact face 1b of the knob 1 and is thus fixed. Since the plate 7 is not inserted, the I-shaped nut 2 is advanced forward appreciably from the stopper 3.

As shown in the front view of FIGS. 10A, 10B, the knob 1 is turned by 90° in the counterclockwise direction or the unclamping direction so that the I-shaped nut 2 becomes parallel to the nut receiving groove 1d. Then, the knob 1 is pulled backward and the plate 7 is put on (see FIGS. 10A, 10B). By the pulling of the knob 1 is cancelled after the plate 7 is put on, the knob 1 moves forward to the fixing position of the plate 7 because of the biasing force of the spring 5 and is stopped (see FIGS. 11A, 1IB). In this state, the I-shaped nut 2 is at a position advanced from the first contact face 1b of the knob 1 by a distance Y and is partially inserted into the nut receiving groove 1d.

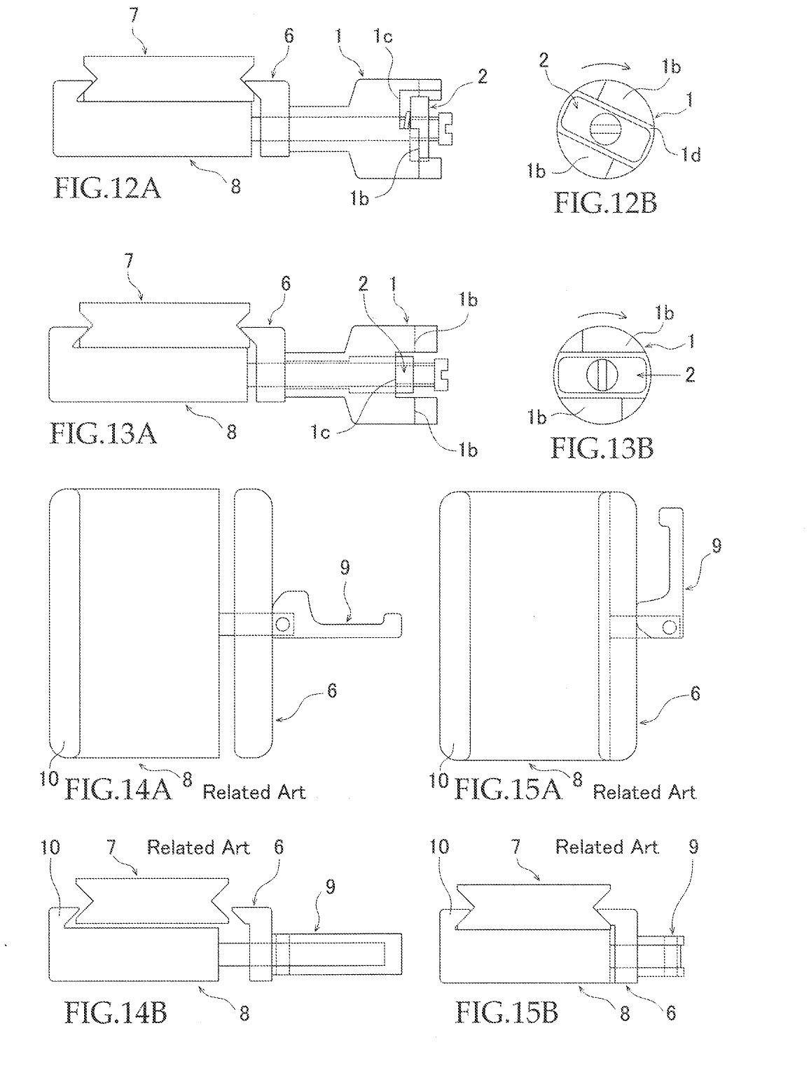

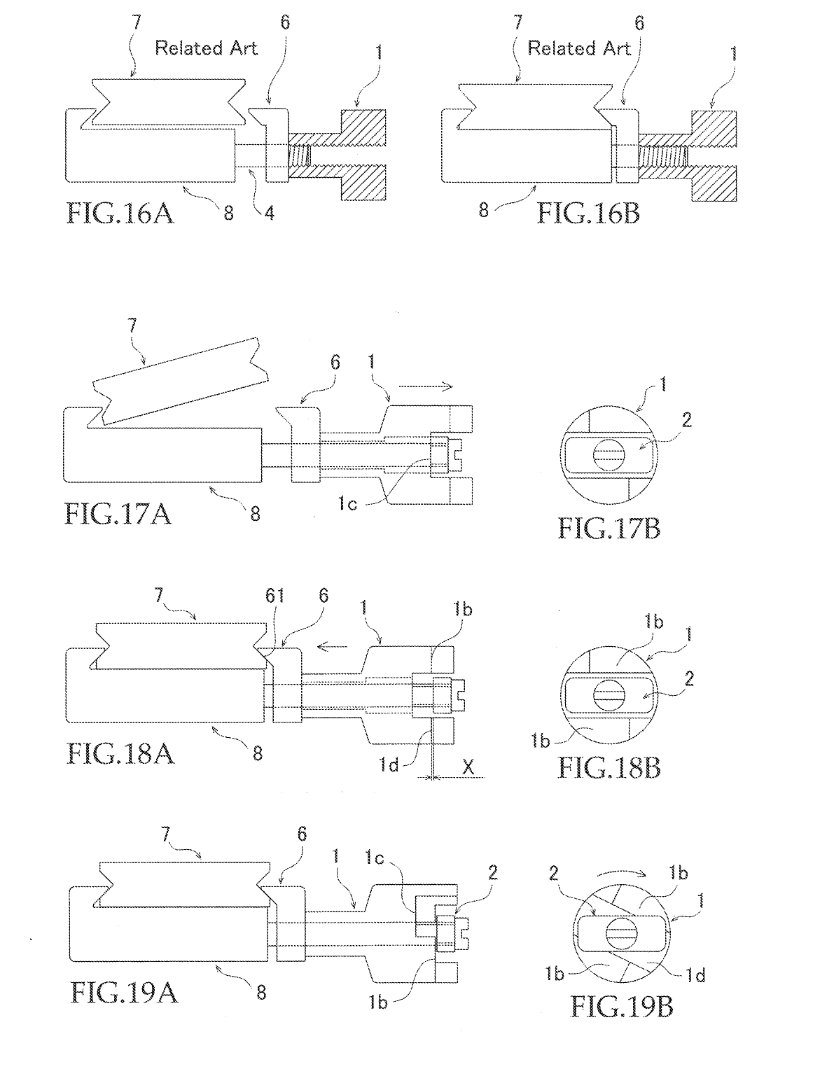

By turning the knob 1 in the clockwise direction or the clamping direction, the I-shaped nut 2 is also tuned together with the turning of the knob 1 and advances into the nut receiving groove 1d. However, a significant number of turns are needed to turn the knob 1 until the I-shaped nut 2 reaches the second contact face 1c. That is, this operation is similar to the operation of the traditional screw-operated clamping mechanism (see FIGS. 12A, 12B). By further turning the knob 1 in the clockwise direction, the I-shaped nut 2 comes in contact with and presses the second contact face 1c so that the plate 7 is fixed (see FIGS. 13A, 13B).

For removing the plate 7, the knob 1 should be turned in the counterclockwise direction or the unclamping direction to move the I-shaped nut 2 backward significantly. Since the I-shaped nut 2 moves only a distance corresponding to one pitch of the thread by each turn, similarly to the traditional screw-operated mechanism, a significant number of turns of the knob 1 in the counterclockwise direction or the unclamping direction are required to move the I-shaped nut 2 backward significantly. Therefore, this operation is similar to the operation of the traditional screw-operated clamping mechanism.

Unless the I-shaped nut 2 is moved backward to reach the stopper 3 so that the I-shaped nut 2 is positioned above the nut receiving groove 1d like the aforementioned state shown in FIGS. 4A, 4B, the normal clamping operational mode continues. In other words, for changing the screw-operated clamping mechanism to the quick clamping operational mode, the I-shaped nut 2 should be moved backward to a position where the I-shaped nut 2 comes in contact with the stopper 3.

As mentioned above, for changing the screw-operated clamping mechanism to the normal clamping operational mode, the I-shaped nut 2 is at a somewhat advanced position where at least a part of the I-shaped nut 2 is positioned inside the nut receiving groove 1d. For this, in this embodiment, the screw-operated clamping mechanism is first set to the aforementioned quick clamping operational mode without the plate 7. That is, the I-shaped nut 2 comes in contact with the first contact face 1b by turning the knob 1 in the clockwise direction or the clamping direction from the state where the I-shaped nut 2 is positioned above the nut receiving groove 1d of the knob 1, after that, the knob 1 is loosened by an angle less than one turn so that the I-shaped nut 2 is positioned above the nut receiving groove 1d, and then the knob 1 is pulled backward, thereby allowing the plate 7 to be put on the plate body 8. In this state, a part of the I-shaped nut 2 enters into the nut receiving groove 1d through a distance created by insertion of the plate 7. By tuning the knob 1 in the clockwise direction or the clamping direction fully from this state, the I-shaped nut 2 further enters into the nut receiving groove 1d is pressed against the second contact face 1c, thereby clamping the plate 7. By keeping the operation of the knob 1 within a range before the I-shaped nut 2 is entirely out of the nut receiving groove 1d, the screw-operated clamping mechanism continue to have the same function as the traditional screw-operated clamping mechanism, without the quick clamping operational mode.

### Second Embodiment

The screw-operated clamping mechanism according to a second embodiment of the present invention is similar to the mechanism shown in FIGS. 1A, 1B, 2, and 3, but omitting the spring 5. That is, the screw-operated clamping mechanism of the second embodiment has the same components except the spring 5 of the screw-operated clamping mechanism shown in FIGS. 1A, 1B, 2, and 3. Since the structures of components of the screw-operated clamping mechanism are the same as the structures of the components of the screw-operated clamping mechanism of the first embodiment, the explanation of the components will be omitted. The screw-operated clamping mechanism comprises a clamp body 8, a shaft 4, a movable pawl 6, a knob 1, a nut (hereinafter, referred to as “I-shaped nut”) 2, and a stopper 3.

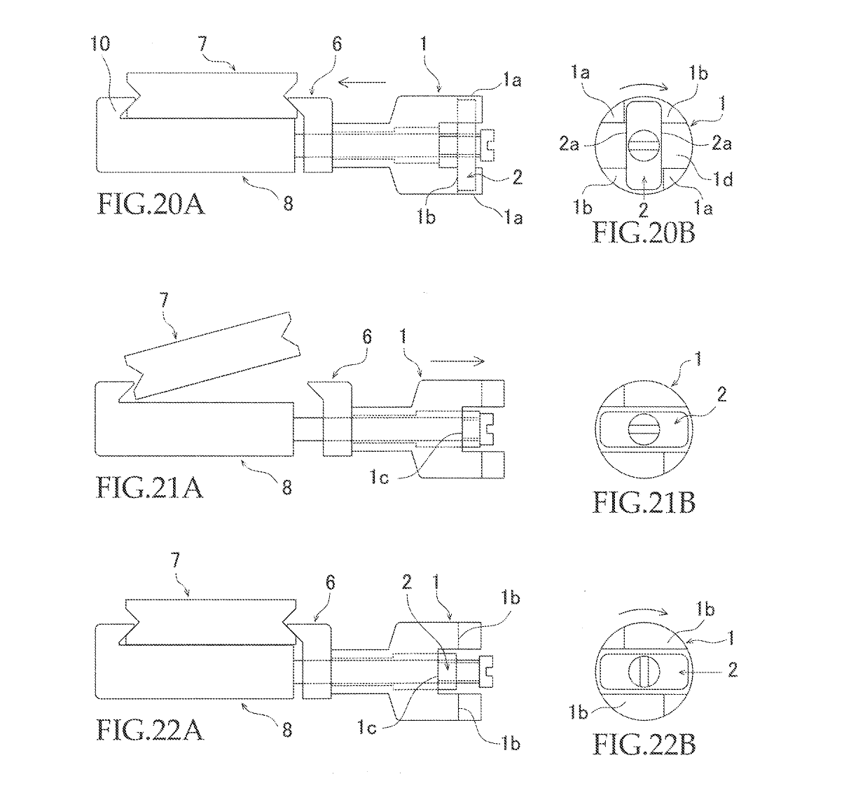

The screw-operated clamping mechanism of this embodiment has no spring 5, but has biasing means 90 such as coil springs between the movable pawl 6 and the side 87 of the clamp body 8 (see FIG. 1A). By the biasing means 90, the movable pawl 6 is always biased in a direction apart from the clamp body 8. Since there is no spring 5 of which biasing force is larger than that of the biasing means 90, the movable pawl 6 presses the knob 1 as shown in FIGS. 17A, 17B when no external force is applied. Accordingly, the movable pawl 6 is in contact with the knob 1 and brings the knob 1 in contact with the I-shaped nut 2.

### [Quick Clamping Operational Mode]

FIGS. 17A, 17B, 18A, 18B, 19A, 19B, 20A, 20B are operational explanatory illustrations of the screw-operated clamping mechanism in a quick clamping operational mode, wherein FIGS. 17A, 18A, 19A, 20A are side views and FIGS. 17B, 18B, 19B, 20B are front views (operational sides) (the clamp body 8 and the movable pawl 6 are omitted). Before the insertion of the plate 7, the knob 1 is turned in the counterclockwise direction or the unclamping direction until the I-shaped nut 2 reaches the stopper 3 as the backmost as shown in FIGS. 17A, 17B. In this state, the knob 1 and the movable pawl 6 are biased toward the I-shaped nut 2 by the aforementioned biasing means 90 and the I-shaped nut 2 is inserted into the nut receiving groove 1d and is in contact with the second contact face 1c of the knob 1. Then, the plate 7 is put on the clamp body 8.

After the plate 7 is put on, as shown in FIGS. 18A, 18B, the knob 1 is moved linearly forward toward the clamp body 8 against the biasing force of the biasing means 90 so that a plate engaging portion 61 of the movable pawl 6 comes in contact with a side of the plate 7. Since the I-shaped nut 2 is positioned at the backmost, the first contact face 1b of the knob 1 is shifted forward from the I-shaped nut 2 so that a space X is created between the first contact face 1b and the I-shaped nut 2.

Then, as shown in FIGS. 19A, 19B, the knob 1 is turned in the clockwise direction or the clamping direction so that the I-shaped nut 2 is kept stopped while the knob 1 is turned. As the knob 1 is further turned, as shown in FIGS. 20A, 20B, the nut locking parts 1a of the knob 1 come in contact with the side faces 2a of the I-shaped nut 2. After that, the knob 1 and the I-shaped nut 2 are simultaneously turned in the same direction or the clockwise direction. By the turning of the I-shaped nut 2, the I-shaped nut 2 moves along the shaft 4 toward the clamp body 8 and thus presses the first contact face 1b of the knob 1 to move the knob 1 and the movable pawl 6 toward the clamp body 8. Therefore, as shown in FIGS. 20A, 20B, the plate 7 is clamped between the movable pawl 6 and the fixed pawl 10, thereby securely fixing the plate 7 on the clamp body 8.

On the other hand, by turning the knob 1 in the counterclockwise direction or the unclamping direction, the I-shaped nut 2 is also turned in the counterclockwise direction together with the knob 1 because of frictional force in the rotational direction between the first contact face 1b of the knob 1 and the I-shaped nut 2 which are in tight contact with each other by the biasing means 90. Therefore, the knob 1 and the I-shaped nut 2 are moved backward. Once the I-shaped nut 2 comes in contact with the stopper 3, the I-shaped nut 2 is not turned in the counterclockwise direction anymore so that the only the knob 1 is turned in the counterclockwise direction. When the I-shaped nut 2 becomes parallel to the nut receiving groove 1d, the I-shaped nut 2 is inserted into the nut receiving groove 1d by the biasing force of the biasing means 90, thus returning to the state shown in FIGS. 17A, 17B. This makes the plate 7 to be easily removed.

Therefore, the quick and secure attachment and removal of the plate 7 is achieved by the minimal operation of turning the knob 1. As a result of this, the screw-operated clamping mechanism of this embodiment has significantly improved mobility in the shooting location while keeping high reliability as the screw-operated clamping mechanism.

### [Normal Clamping Operational Mode]

FIGS. 21A, 21B, 22A, 22B are operational explanatory illustrations of the screw-operated clamping mechanism in a normal clamping operational mode, wherein FIGS. 21A, 22A are side views and FIGS. 21B, 22B are front views (operational sides) (the clamp body 8 and the movable pawl 6 are omitted). Before the insertion of the plate 7, the knob 1 is turned in the counterclockwise direction or the unclamping direction until the I-shaped nut 2 reaches the stopper 3 as the backmost as shown in FIGS. 21A, 21B, similarly to the aforementioned quick clamping operational mode. In this state, the knob 1 and the movable pawl 6 are biased toward the I-shaped nut 2 by the aforementioned biasing means 90 and the I-shaped nut 2 is inserted into the nut receiving groove 1d and is in contact with the second contact face 1c of the knob 1. Then, the plate 7 is put on the clamp body 8.

By turning the knob 1 in the clockwise direction or the clamping direction, the I-shaped nut 2 is turned together with the turning of the knob 1 so as to move forward within the nut receiving groove 1d. Since the I-shaped nut 2 moves only a distance corresponding to one pitch of the thread by each turn, a significant number of turns of the knob 1 are required until the plate engaging portion 61 of the movable pawl 6 comes in contact with the side of the plate 7. This operation is similar to the operation of the traditional screw-operated clamping mechanism. By turning the knob 1 in the clockwise direction, the I-shaped nut 2 comes in contact with and press the second contact face 1c of the knob 1, thus fixing the plate 7 (see FIGS. 22A, 22B).

For removing the plate 7, the knob 1 should be turned in the counterclockwise direction or the unclamping direction to move the I-shaped nut 2 backward significantly. Since the I-shaped nut 2 moves only a distance corresponding to one pitch of the thread by each turn, a significant number of turns of the knob 1 in the counterclockwise direction or the unclamping direction are required to move the I-shaped nut 2 backward significantly. This operation is similar to the operation of the traditional screw-operated clamping mechanism.

Unless the I-shaped nut 2 is moved backward to reach the stopper 3 like the aforementioned state shown in FIGS. 21A, 21B, the normal clamping operational mode continues.

As mentioned above, any one of the screw-operated clamping mechanisms mentioned above comprises the knob 1 having the first and second contact faces 1b, 1c which are formed at a side facing the I-shaped nut 2 and are stepped between them as shown in FIG. 3, whereby the I-shaped nut 2 is moved forward and backward by turning the knob 1. The I-shaped nut 2 is turned by the turning of the knob 1 so as to move forward and backward along the external thread 41 of the shaft 4. When the I-shaped nut 2 is turned, there are two conditions where the I-shaped nut 2 is sandwiched by the nut locking parts 1a of the knob 1 and is contact with the first contact face 1b and where the I-shaped nut 2 is inserted into the nut receiving groove 1d of the knob 1. When the I-shaped nut 2 moves while being sandwiched by the nut locking parts 1a and is contact with the first contact face 1b, the screw-operated clamping mechanism is in the quick clamping operational mode fully exhibiting the feature of the present invention. When the I-shaped nut 2 moves while the I-shaped nut 2 is inserted into the nut receiving groove 1d, the screw-operated clamping mechanism is in the normal clamping operational mode similar to the traditional screw-operated clamping mechanism.

Though the embodiments of the present invention are described in the above, the present invention is not limited to the aforementioned embodiments and various modifications may be made without departing from the scope in technical idea as defined in the appended claims, the specification, and the drawings. It should be noted that configurations, structures, materials exhibiting the same functions and effects even not described directly in the specification and the drawings may be contained in the scope in technical idea of the present invention. For example, though the I-shaped nut 2 is used as a nut in the aforementioned embodiment, the nut is not limited to I-shaped and may have any other configuration. Though the knob 1 is structured to be turned by an angle range of 90° in the quick clamping operational mode in the aforementioned embodiment, the configuration of the nut 2 or the configuration of the nut locking part la may be modified to allow the turning of the knob 1 by an angle smaller than 90° or an angle larger than 90°.

What we claim is:

1. A screw-operated clamping mechanism comprising at least:
a clamp body having a plate mounting face on which a plate is mounted and a fixed pawl formed on the upper surface at an end of one of sides;
a shaft attached to a side, opposite to the side where said fixed pawl is formed, of said clamp body;
a movable pawl which is slidably attached to said shaft;
a knob which is disposed on the back side of said movable pawl and is allowed to slide and turn relative to said shaft;
a nut which is allowed to turn and screw to a threaded portion formed in said shaft penetrating said knob; and
a stopper attached to an end of said shaft, wherein
said knob is provided, at a side facing said nut, with a first contact face with which said nut comes in contact, a concave nut receiving groove formed in said first contact face, a second contact face which is formed at the bottom of said nut receiving groove and with which said nut comes in contact, and a nut locking part which projects from said first contact face and comes in contact with a side of said nut so that said knob and said nut are turned integrally, and wherein
by bringing the side of said nut in contact with said nut locking part or said nut receiving groove of said knob and turning said nut together with said knob, said nut is pressed against said first contact face or said second contact face of said knob so as to move said movable pawl toward said clamp body via said knob and press said movable pawl against said plate put on said plate mounting face so that said plate is clamped and fixed between said movable pawl and said fixed pawl.

2. A method of using a screw-operated clamping mechanism as claimed in claim 1, comprising steps of:
previously moving said knob backward and inserting said nut into said nut receiving groove to move said movable pawl backward and, in this state, putting said plate on said clamp body;
moving said knob forward relative to said nut to position said nut above said nut receiving groove; and
turning said knob in the clamping direction until said nut faces said first contact face and further turning said knob in the clamping direction to turn and move said nut forward until said nut is pressed against said first contact face so that said movable pawl is pressed against said plate via said knob so as to clamp and fix said plate between said movable pawl and said fixed pawl.

3. A method of using a screw-operated clamping mechanism as claimed in claim 1, comprising steps of:
previously moving said knob backward and inserting said nut into said nut receiving groove to move said movable pawl backward and, in this state, putting said plate on said clamp body; and
turning said knob in the clamping direction while said nut is inserted in said nut receiving groove so as to turn said nut in said nut receiving groove and move said nut forward until said nut is pressed against said second contact face so that said movable pawl is pressed against said plate via said knob so as to clamp and fix said plate between said movable pawl and said fixed pawl.
